(19) United States
(12) Patent Application Publication
(10) Pub. No.: US 2016/0077632 A1
(43) Pub. Date: Mar. 17, 2016

(54) Layer Electrode For Touchscreen

(71) Applicant: POLYIC GMBH & CO. KG, Fürth (DE)

(72) Inventors: Andreas ULLMANN, Zirndorf (DE); Manfred WALTER, Nurnberg (DE)

(21) Appl. No.: 14/889,023

(22) PCT Filed: May 6, 2014
(86) PCT No.: PCT/EP2014/059215

§ 371 Date: Nov. 4, 2015

(30) Foreign Application Priority Data
May 6, 2013 (DE) 10 2013 104 640.1

(51) Int. Cl. G06F 3/044; G06F 3/041

(52) U.S. Cl. CPC G06F 3/044; G06F 3/0416; G06F 2203/04103

(57) ABSTRACT

The invention relates to a layer electrode for a touchscreen, in particular one which makes the edge region of the transparent input field matrix useful for further input fields.

The invention relates to a layer electrode, in particular for a capacitive touchscreen.

Touchscreens with layer electrodes which have a capacitively functionalized active and transparent surface have been known until now. The touchscreen is based on a pixel matrix which defines input fields. The meaning of capacitively functionalized is that transmitter and receiver electrode surfaces interact on the transparent input field, with the result that when the input field is covered or crossed a capacitive coupling occurs which can be converted into a digital signal. The more completely the input field is covered with coupling transmitter and electrode surfaces, the more clearly the position of the signal can be allocated to the matrix and the stronger the signal is.

As a rule the transparent transmitter and receiver electrodes are arranged on the transparent surface such that the supply lines and contacts for these electrodes are guided from the center out to the edge and then along a non-transparent edge region, the so-called wiring region, to the plug connector.

In this design of a layer electrode of a touchscreen such as is usual for smartphones and/or tablet computers, it is possible to distinguish between an inner edge region with input fields on the active transparent surface and an outer edge region (wiring region) which completely borders the inner edge region, is not necessarily transparent any longer and is covered with electrical supply lines for the electrode arrays on the transparent active surface. Interfering signals are more likely in both edge regions than in the center of the transparent and active operating surface.

In the case of the input fields of the inner edge region the problem arises that here the ratio of electrode surface to surface which is covered by supply lines and/or the galvanic isolations becomes ever smaller. In particular this is because the supply lines for the central input fields lead through the outer input fields. In principle this results in a reduced reliability and strength of the input fields operated in the inner edge region.

In the directly adjoining, not necessarily transparent, outer edge region the problem arises that as the number of input fields of the touchscreen increases an increasing number of supply lines is also to be accommodated in the outer edge. It is to be borne in mind that the supply lines can also interact with each other and with the electrode surfaces of the input fields in the inner edge region and thus they lead to interfering signals.

The object of the present invention is therefore to specify an arrangement for electrode surfaces and supply lines in the edge region of a layer electrode of a touchscreen by which undesired couplings of the supply lines are suppressed as far as possible.

This object is achieved by the subject of the present application, as disclosed by the claims, the description and the figures.

A general discovery of the present invention is that the outer edge region is not necessarily transparent and that this non-transparency can be made useful for the coverage with strengthening electrode arrays, in particular also with supply lines, bridging lines and grounding lines, which couple with the electrode surfaces of the transparent region or are connected in an electrically conductive manner.

In particular, according to the invention, parasitic couplings in the wiring region are changed and replaced by couplings in the wiring region generated in a targeted manner which strengthen the signals on the operating surface.

In particular, the present invention shows, for the first time, an arrangement of supply lines, bridging lines, grounding lines and vias in the outer edge region of a layer electrode of a touchscreen in which these lines and vias are, as far as possible, functionalized and in addition used to strengthen the signals of the input fields of the inner edge region.

The wiring region in the outer edge region of the electrical lines by which the transmitter and receiver electrodes of the touchscreen are contacted is covered with electrodes over as large an area as possible. These electrode surfaces are connected and contacted such that on the one hand they suppress parasitic couplings which the coverage, usual until now, with supply lines build up with the neighboring receiver and/or transmitter electrodes and on the other hand the ratio of electrode surface to supply line surface in the inner edge region of the touchscreen shifts in favor of larger electrode surfaces and thus higher signal reliability.

The quantity of interfering signals is thus minimized relative to the edge coverages, usual until now, of the layer electrodes of touchscreens and a strengthening of the signals in the inner edge region is achieved by coupling generated in a targeted manner.

The invention is furthermore explained in more detail with reference both to figures which describe the state of the art, known from DE 10 2012 112 445.0, and to further figures which describe selected embodiments of the invention:

From DE 10 2009 014 757, a material for a transparent conductive layer is known which comprises a transparent film covered with non-transparent, conductive grid meshes, wherein the coverage is carried out in the form of thin, non-transparent wires such that the film is transparent for the human eye and is still conductive.

According to a preferred embodiment of the invention the above-described conductive and transparent film is used as conductive coverage, for example in the form of the electrode arrays and/or supply lines in the transparent input field.

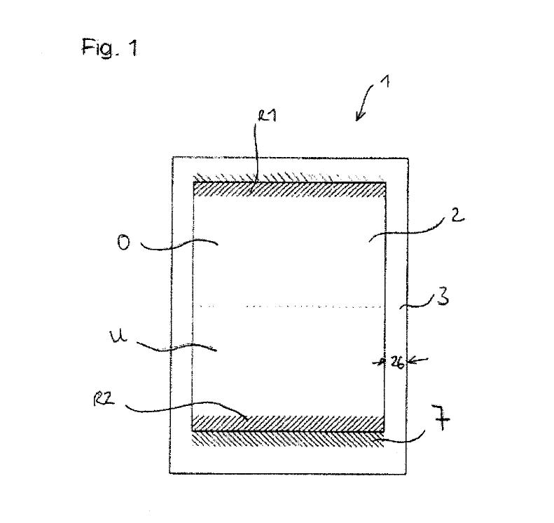

FIGS. 1 to 4 show the state of the art.

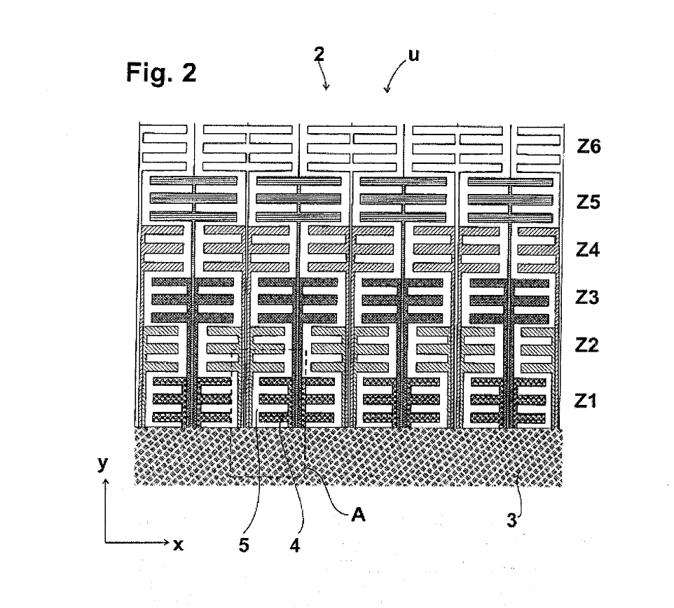

FIG. 1 shows a touchscreen 1, for example a smartphone or a tablet computer. This comprises the actual touchscreen with the transparent input field 2, as well as an opaque outer and non-transparent edge region 3. The input field 2 is, as shown in FIG. 2, covered with a layer electrode in which the supply lines for the individual input fields, in each case comprising interacting transmitter and receiver electrodes, are guided from the inside out through the input fields 2 located further out, here through the receiver electrode arrays 5, as shown in FIG. 2, outwards to the opaque outer edge region. In FIG. 1 the embodiment is shown in which the supply lines for the non-transparent edge region 3 are only guided downwards and upwards. From the center (indicated by the dashed line) out, the supply lines of the upper side O are guided upwards into the shaded edge region R1 and the supply lines of the lower side U are guided downwards into the shaded edge region R2. The shaded edge region R2 comprises an inner edge region which lies in the transparent part with transparent input fields 2 of the touchscreen and an outer edge region which lies in the no longer transparent edge region 3 of the touchscreen.

The outer edge region 3 comprises not only the sides at the top and bottom of the layer electrode but, naturally, also the sides on the left and right, thus the whole circumference of the layer electrode. The wiring region always lies in the outer edge region and can comprise parts thereof or the whole outer edge region.

In the upper half O of the input field matrix 2 the supply lines for the transmitter electrodes 4 are guided over the edge region R1, in the lower half U they are guided over the edge region R2. Now it is inevitably the case that the density of supply lines is greatest in the inner edge regions R1 and R2; it decreases successively towards the center of the input field matrix 2. The ratio of actual sensor surface (total of the transmitter and receiver electrode surfaces) to surface covered with supply lines is smallest in the edge regions R1 and R2. This means that in the case of these sensor surfaces the signals triggered by a touch are weakest in edge zones. In addition, interfering signals occurring, which are caused by an interaction of the supply lines with the receiver electrodes, are also greatest there.

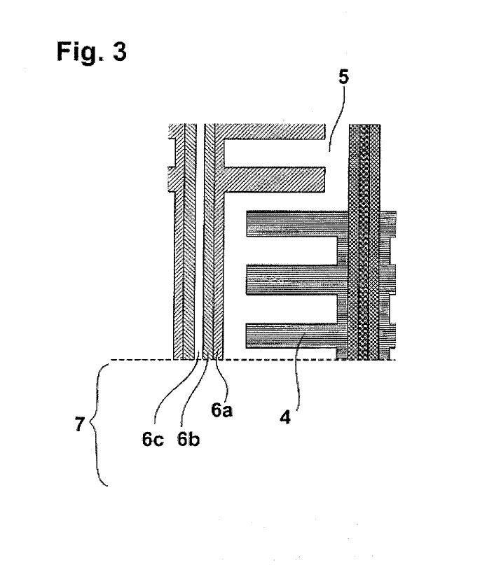

FIG. 2 shows a layer electrode according to the state of the art, as known from DE 10 2012 112 445.0, with an outer, non-transparent edge region 3 represented shaded and an inner edge region Z1 bordering this, in which the ratio of electrode surface to supply line surface is clearly reduced relative to the central region, represented by Z5 and Z6. A region A from FIG. 2 is shown in detail, cut out and enlarged, in FIG. 3.

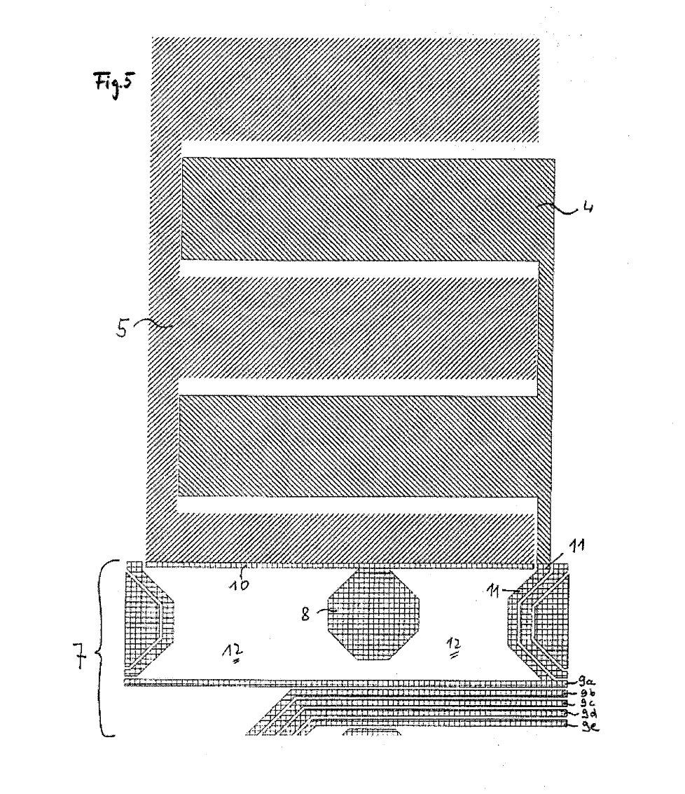

FIG. 3 shows the region A from FIG. 2 and shows in the center there a dashed line which represents the boundary between the inner, e.g. R2 from FIG. 1, and the outer edge region 7. The outer edge region at this point is, for example, the wiring region 7. This wiring region 7 forms the outer edge region 3 and directly adjoins the inner edge region, with the maximum distance of a galvanic isolation gap which lies, for example, in the range of from 10 to 300 μm. However, as the majority of the embodiment examples in FIGS. 5 to 8 show, the wiring region 7, for example in the form of the contact surface 10, normally directly adjoins the electrode surface 5.

The inner edge region, thus for example R2, lies above 7, as mentioned isolated by the dashed line, which is only an illustration. Visible there are the supply lines 6a to 6c for the inner input fields as well as the transmitter electrode array 4 which, according to the embodiment shown here, runs in a meandering or interdigital manner, as disclosed in the application DE 10 2012 112 445.0. A part of the receiver electrode array 5, likewise meandering, the surface of which is bordered by the supply lines 6a to 6c is to be seen meshing with the transmitter electrode array 4 in an interdigital manner.

The transmitter electrode 4 interacts capacitively with the receiver electrode 5 and in this way forms an input field. However, the receiver electrode 5 also interacts with the supply lines 6a to 6c by which the transmitter electrodes are electrically contacted in the row regions Z2, Z4 and Z6 lying successively inwards, as shown in FIG. 2. The danger caused by this of interfering signals has the effect that a touch in the row region Z1 may be interpreted as lying too far inwards (thus shifted in the +y-direction).

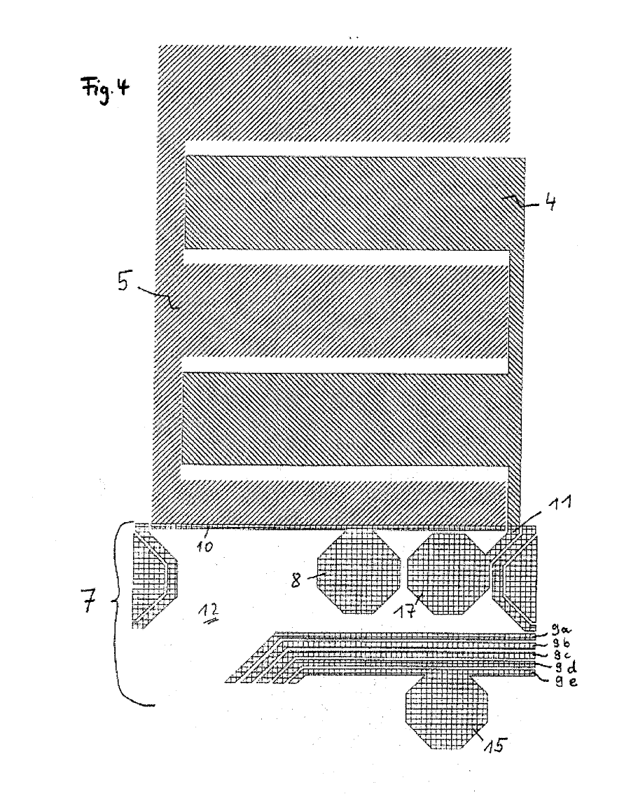

FIG. 4 also shows a detail of the layer electrode of the state of the art according to FIG. 2, but without the bundle of supply lines 6a to 6c here, rather with an identically large surface which could lie, for example, bordering to the left of the one shown in FIG. 3. Here the focus is on the representation of the wiring region 7. According to the state of the art shown here this comprises essentially contact vias and bridging lines (e.g. 17, 8) as well as supply lines (e.g. 9a to 9e) which are guided to a so-called tail of the touchscreen with which the latter can be connected to a plug connector. The transmitter electrode 4 is galvanically connected to the via 17 via a connecting line 11. For example, the via 17 can be electrically connected to a via 15 via a bridge and thus an electrical contact to the supply line 9e can be produced without a short circuit with the supply lines 9b to 9d lying in-between. For this, an electrical insulation layer which covers the supply lines 9a to 9e and does not cover the vias 17, 8 and 15 is provided in the wiring region 7. Thus a bridge, i.e. a connecting line, is guided between the vias 17, 8 and 15, without an undesired contacting to one of the supply lines 9a to 9d being produced.

The supply lines, bridging lines, grounding lines and vias in the wiring region 7 which lies in the non-transparent edge region 3 are, like all other non-transparent electrically conductive regions, made for example of metal, metal alloy or a corresponding paste, such as printable silver paste, in particular conductive silver paste, graphite, carbon black, metal alloy and/or metal: silver, aluminum, copper, gold, as well as any alloys.

The substrate of the layer electrode is, in principle, transparent, in order that the electrode arrays for the touchscreen can be applied thereto. As a rule the coverage with electrically conductive material in the transparent region is smaller than the coverage in the non-transparent outer edge region, which is also called the wiring region. Transparent films such as those made of PET (polyethylene terephthalate), PC (polycarbonate) are particularly beneficial to process as substrate. In addition the thinnest non-flexible transparent materials, such as a thin glass disk, a transparent ceramic etc. are also suitable.

According to FIG. 4 the via 8 is connected to the receiver electrode 5 via a contacting surface 10.

It is recognizable that the contacting surface 10 which is connected to the via 8 on the one hand and to the receiver electrode 5 on the other hand and the via 17 which is connected to the transmitter electrode 4 via the supply line 11 lie directly next to each other.

The contacting surface 10 lies in the outer edge region, thus the not necessarily transparent wiring zone.

The surface 12 remaining white here in the outer edge region 7 which is without conductive coverage, thus unused, is likewise shown.

FIG. 5 now shows, for the first time, an embodiment example according to the invention. According to this first embodiment, in the wiring region 7 as large as possible an interaction zone 12 is formed in which there are transmitter-equivalent conductive regions, for example supply lines 11 and 9a, which are connected to the transmitter electrode 4 and receiver-equivalent conductive regions, for example contact surface 10 and via 8, which are connected to the receiver electrode 5. In this interaction region a capacitive functionality is thus formed which can also be made useful as input field in the non-transparent edge region 7.

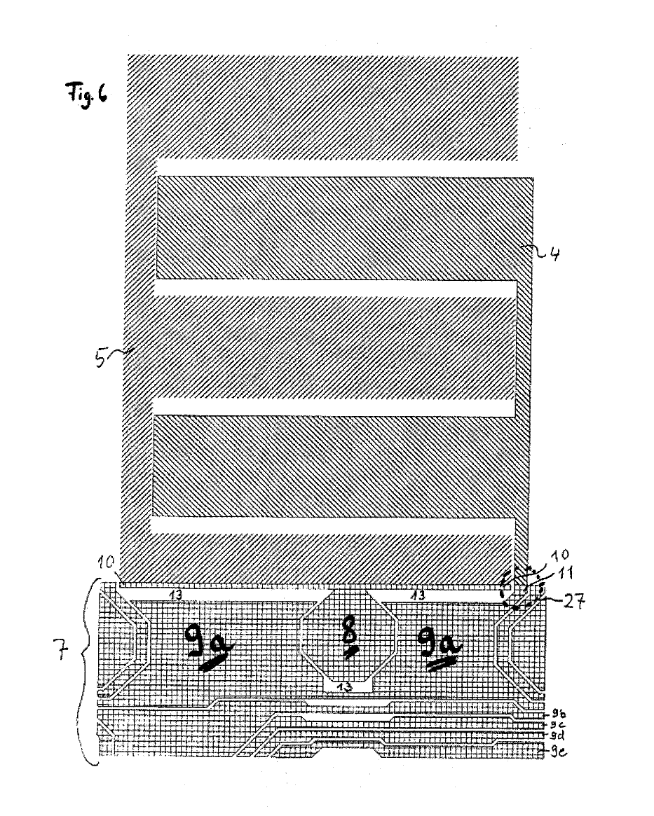

For example, as shown in FIG. 5, for this the supply line 11 which is connected to the transmitter electrode 4 is connected, without via 17 (FIG. 4), to the closest supply line 9a via a simple contacting 27 (FIG. 6). A capacitively switchable input field is then provided between the supply line 9a which is transmitter-equivalent and the via 8 which is connected via the contact surface 10 to the receiver electrode 5, thus is receiver-equivalent. The via 8 acts as receiver, the supply line 9a as transmitter.

To improve this signal in the wiring region 7, according to an embodiment example according to FIG. 6, the coverage with electrically conductive material is increased in the interaction zone 12.

FIG. 6 shows the same view as FIGS. 4 and 5, but according to another embodiment example of the invention.

The wiring region 7 now shows a much higher coverage with conductive material. The line 9a from FIG. 5, which is connected to the supply line 11 and thus to the transmitter electrode 4, is broadened according to the embodiment shown here and now almost fills the whole interaction zone 12. Only the gap 13 which allows a galvanic isolation between the regions 10 and 8 on the one hand, which are receiver-equivalent, and the region 9a, which is transmitter-equivalent, still shows non-conductive regions within the interaction zone 12, which was almost without conductive coverage according to the state of the art, as is recognizable in FIG. 4.

In the non-transparent wiring region 7, however, the coverage with conductive material is, in principle, not disadvantageous for the layer electrode, as the transparency plays no role at that point. An interaction zone 12 which is enlarged relative to FIG. 5, and thus improved, is therefore created in the wiring region 7 by the embodiment shown here, in which the broadened supply line 9a almost completely surrounds the via 8 and the gap 13 galvanically isolates the supply line 9a from the contact surface 10.

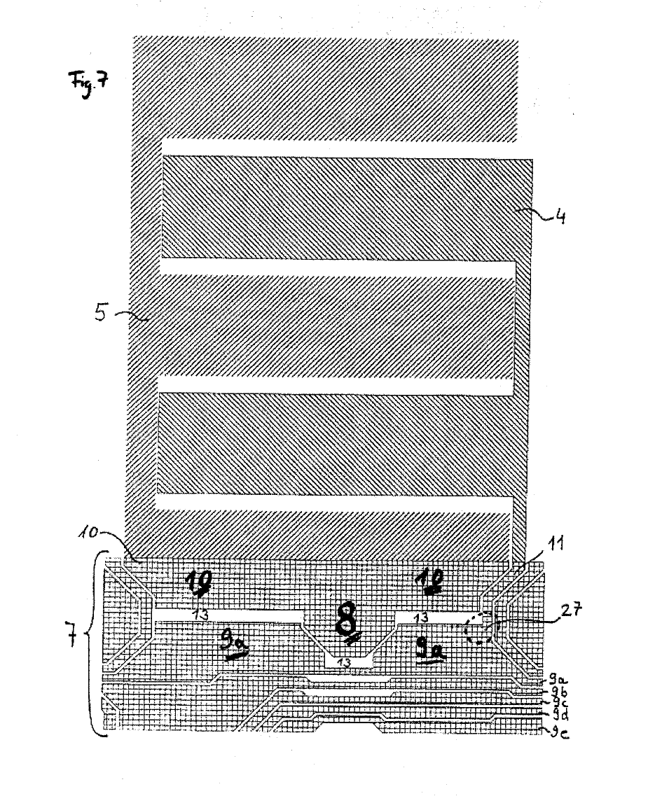

A further embodiment is shown in FIG. 7. Again, the focus is on the wiring region 7 shown at the bottom. Here, in direct comparison with the embodiment example shown in FIG. 6, not only the transmitter-equivalent supply line 9a but also the receiver-equivalent contact surface 10 is broadened. The contact surface 10 passes into the via 8 in a flowing manner. The interaction zone 12 is now almost completely covered with electrode surface due to the broadened contact surface 10 on the one hand and the broadened supply line 9a on the other hand and is thus made useful for the whole device.

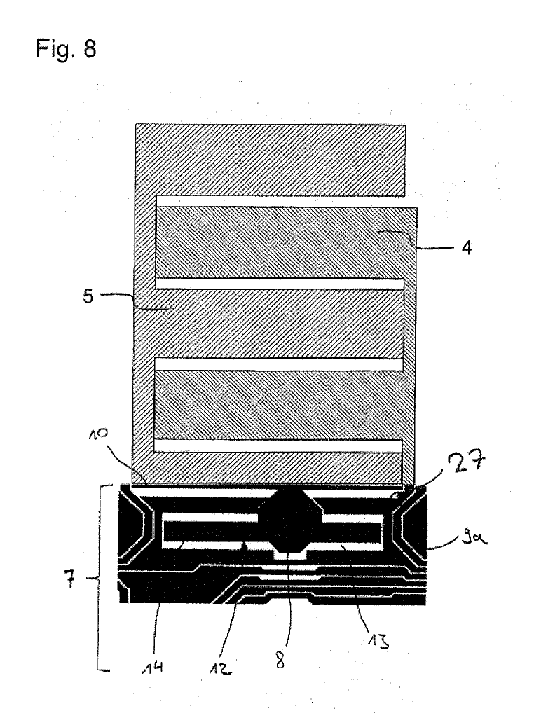

FIG. 8 again shows another embodiment of the wiring region 7. Here, the via 8 is extruded in the form of a bar electrode 14. The supply line 9a, now formed very complex geometrically, completely surrounds the bar electrode 14, galvanically isolated by the gap 13, with the result that a very extensive and thus signal-intensive interaction zone 12 is provided.

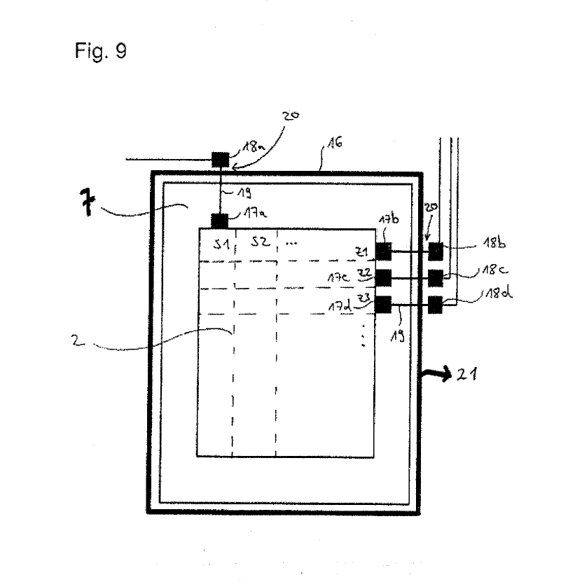

FIG. 9 shows a further aspect of the invention. According to this embodiment it is provided to galvanically connect a grounding line 16, provided in the touchscreen, which passes through the whole outer edge 3 and borders the whole transparent active input field matrix 2, to a transmitter or receiver function. This embodiment makes use of the grounding line 16 in a similar way to how the embodiments shown in FIGS. 5 to 8 make use of the supply lines 9a to 9e and contact surfaces 10.

For this, a line 21 is guided from the grounding line 16 to a controller (not shown) by which the grounding line is then connected either as receiver-equivalent or as transmitter-equivalent. Interaction zones 20 are again created by the formation of intersections with the grounding line.

The grounding line 16 obtains a double function, firstly the grounding and secondly as receiver- or transmitter-equivalent electrode surface. The grounding line 16 lies in the outer edge region of the layer electrode and at a distance from the inner edge region of the transparent region, but this distance is minimal and merely serves to maintain the galvanic isolation between the electrode arrays of the operating surface on the one hand and the grounding line on the other hand. The distance lies, for example, in the range between 10 and 300 μm.

Alternatively or in addition, the grounding line 16 can be short-circuited with a supply line for a transmitter or receiver electrode array and thus a further interaction zone 20 with transmitter- or receiver-equivalent conductive regions can be created.

Until now, a column electrode S1 of the input field matrix 2 was connected to the via 18a and a supply line via a via 17a and a bridging line 19. The bridge, as represented in the previous figures, is necessary to bridge supply lines (not represented) in the wiring region 7 without galvanic connection. The via 18a here is arranged next to the grounding line 16. The grounding line 16 is usually necessary to prevent interfering signals which occur due to an interaction between the via 18a and elements in the wiring region 7. For this, the grounding line 16 is grounded/earthed.

According to the embodiment example of the invention shown here, for example, the grounding line 16 is short-circuited with the input fields of the row Z1 of the matrix 2. An interaction zone 20 which acts exactly like the transmitter and receiver electrode surfaces S1-Z1 is then formed between the via 18a and the grounding line 16.

To improve the signals, both the grounding line 16 and the vias 18a to 18d can again be formed with corresponding surface broadening.

An operator holding, for example, a smartphone with the arrangement shown in FIG. 9 in their right hand can then, for example, slide their thumb along the opaque right-hand edge of the smartphone and in this way slide over the interaction zones 20 successively, and thus e.g. operate a scrollbar represented on the screen.

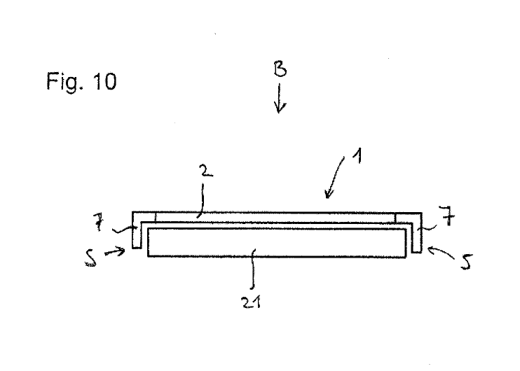

FIG. 10 represents how the edge region of touchscreens, as is usual for example in the case of smartphones, can obtain entirely new functionalities due to the present invention.

The touchscreen can be arranged, in viewing direction B, above the screen of the smartphone 21 such that the wiring region 7 at least partially covers the side edges S of the smartphone 21. Here a formation of the touchscreen 1 on flexible carrier material is particularly advantageous. If an operator slides their finger over the side edge S of the smartphone, an input is now possible. Until now input elements on the side edges S were usually formed with conventional operating keys on smartphones. Due to the present invention the touch functionality can also overlay the whole edge region of a touchscreen and conventional keys can be dispensed with entirely.

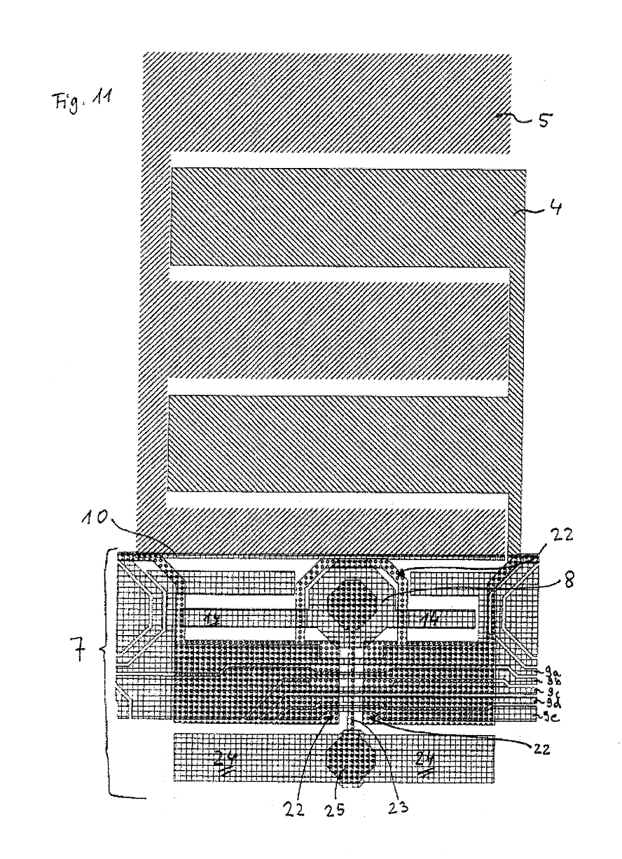

A further embodiment of the invention is illustrated in FIG. 11.

Here an extension of the principle known from FIG. 8 of a single-layered layer electrode to a two-layered layer electrode is shown. In the single-layered region the broadened supply line 9a and the via 8 extended around the bar electrode 14 interact in the wiring region 7 as a transmitter/receiver pair. In the two-layered case shown here, an interaction zone over several planes of the touchscreen can be created by means of an insulation layer.

For this, according to the embodiment example from FIG. 11, a further transmitter electrode 22 is provided in another layer plane. The receiver electrode 5 is connected to a via 25 via the contact surface 10, the via 8 and a bridging line 23 which lies in a different plane from the contact surface 10. The bridging line 23 connects two planes to each other. The via 25 contacts a supply line (not represented) by which an electrical contact to a controller for the receiver electrode 5 is produced. In order to prevent an electrical contact between the supply lines 9 and the bridging line 23, an insulation layer (not shown) is provided between the two. This normally covers the whole wiring region 7 over the whole surface, wherein the vias 8 and 25 are omitted. The transmitter electrode 22 is now also formed on this insulation layer. Together with the via 8, the bar electrode 14 and a bar electrode 24, it forms an input field that is capacitive in two layers outside the actual transparent input field matrix of the touchscreen. The transmitter electrode 22 is controlled individually, for example, via the controller (not shown) and is electrically connected to one of the transmitter electrodes 4 of the transparent input field matrix 2.

This embodiment shown in FIG. 11 is a combination of the embodiments of FIG. 8 with a second electrode plane.

The second electrode plane shown here can also be combined, for example, with a first layer electrode according to the state of the art, as known for example from FIG. 4.

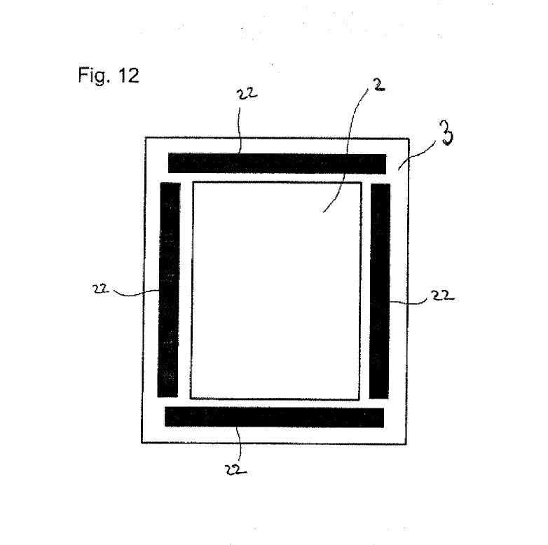

FIG. 12 shows a possible arrangement of transmitter electrodes 22 of the second electrode plane, as explained in FIG. 11. The transmitter electrodes 22 can extend, for example, as bar-shaped electrodes 22 over the whole length of one or all sides of the outer non-transparent edge region 3 and be connected individually via supply lines, not shown, without connection to the transparent input field matrix 2.

The transmitter electrodes 22 are preferably chosen to be as large as possible, in order to create a sufficiently large, and thus sensitive, input field. Due to the arrangement in a second layer, only small limitations in respect of this geometric extent result. The transmitter electrode 22 is advantageously formed with a surface which approximately corresponds to the surface of one of the fingers of the transmitter or receiver electrodes, as shown in FIGS. 5 to 8.

The input field matrix 2 shown in FIGS. 5 to 8 and 11 has a typical height of from 5 to 12 mm, preferably 8 mm. The outer, non-transparent edge region 3 has a typical width 26 (see FIG. 1) of from 3 to 7 mm, preferably 4 mm.

By means of the invention a possibility for compensating for the detection deficiencies described at the beginning is created in the edge region of a touchscreen. The small useful-to-interfering signal ratio in the row region Z1 is increased by the useful signal now produced in the wiring region. Inaccuracies in the position detection are compensated for, as far as possible.

The embodiment examples all start from the meandering and/or interdigital electrode surface arrangement which is described in the application DE 10 2012 112 445. However, the proposed changes in the non-transparent edge region relate to all layer electrode arrangements for touchscreens conceivable until now and in the future. Advantages of the present invention, in particular with regard to smartphones and tablet computers, are to be seen in particular in the improved spatial resolution in the edge region and in the operation by gestures, and are for example the following:
1) In edge zones of the touchscreen virtual operating elements, e.g. so-called slides on the left-hand and right-hand edge, are often displayed on the screen on the basis of software. For the operation of these slides a high spatial resolution of the touch process in the edge zone is necessary. Virtual operating elements for calling up a dropdown menu are likewise often located in the edge region.
2) The gesture control is improved if a touch functionality is also provided in the non-transparent edge region. For example images are represented on the touchscreen. It is possible to scroll e.g. from one image to another by the gesture “swiping from left to right”. By the gesture “swiping from left to right while sliding over the edge of the touchscreen” on the other hand it is intended, not to scroll between the pages, but e.g. to change from one image album to the next. These gestures are already used according to the state of the art, but are only distinguishable from each other with difficulty in respect of the signals provided by the touchscreens according to the state of the art. In order, namely, to also detect the movement direction in addition to the position, at least two neighboring columns have to be slid over. Thus, according to the state of the art, the fact that an edge of the touchscreen was slid over by a finger is only detected if the finger has already moved significantly towards the center of the touchscreen. However, it is then possible to confuse it with the gesture “swiping from left to right”. By means of the invention the occurrence of such errors is reduced.

The invention relates to a layer electrode for a touchscreen, in particular one which makes the outer edge region of the transparent input field matrix useful for further input fields by coupling produced in a targeted manner.

1. Layer electrode for a capacitive touchscreen, comprising:
a transparent input field matrix of a given first area and a non-transparent edge region of a given second area with electrically conductive regions having supply lines formed such that they can be coupled to a connecting contact and are useful as transmitter-equivalent and receiver-equivalent electrode surfaces, wherein in combination with galvanic connection, the transmitter-equivalent and receiver-equivalent electrode surfaces form at least one interaction zone which form a non-transparent input field of an input field matrix comprising the second area forming a broadened input field area relative to the input field matrix first area.

2. Layer electrode according to claim 1, wherein the conductive regions are supply lines and/or bridging lines in the non-transparent edge region.

3. Layer electrode according to claim 1, wherein the electrically conductive regions are contact surfaces and/or grounding lines in the non-transparent edge region.

4. Layer electrode according to claim 1, wherein the galvanic connection is a conductive contact between a supply line for an electrode surface within the transparent input field matrix and the next supply line (9a) of a wiring region.

5. Layer electrode according to claim 1, wherein the galvanic connection is a conductive contact between a grounding line and a connection to input field rows and/or columns of the first area input field matrix.

6. Layer electrode according to claim 1, wherein the electrically conductive regions of the non-transparent edge region are formed such that they are connected via vias to a connecting contact which is formed to connect the layer electrode to control and/or evaluation electronics of the touchscreen.

7. Layer electrode according to claim 1, in which transmitter- and/or receiver-equivalent electrode surfaces in the non-transparent edge region form bar electrodes.

8. Layer electrode according to claim 1, wherein the transmitter- and/or receiver-equivalent electrode surfaces in the non-transparent edge region either are galvanically connected to at least one transmitter or receiver electrode array of the input field matrix and/or can be controlled individually as a transmitter or receiver electrode surface singly.

9. Layer electrode according to claim 1 which is formed in one layer.

10. Layer electrode according to claim 1 which is formed in two layers on two planes.

11. Layer electrode according to claim 10, wherein the receiver-equivalent electrode surfaces of the two planes are connected to each other and/or the transmitter-equivalent electrode surfaces of the two planes are connected to each other by two vias and a bridging line.

12. Layer electrode according to claim 10, wherein bridging lines which connect the transmitter-equivalent electrode surfaces and/or the receiver-equivalent electrode surfaces are in each case galvanically isolated by an insulation layer.

13. Layer electrodes according to claim 1, wherein the connecting contact is a via, a contact via, and/or a controller.

14. Layer electrode according to claim 1, wherein the length of an input field lies in the range of from 5 to 12 mm.

15. Layer electrode according to claim 1, wherein the length of 55 the input field is greater than its width.

16. Layer electrode according to claim 1, wherein the non-transparent edge region has a width which lies in the range of from 3 to 7 mm.

17. Layer electrode according to claim 1, wherein at least a part of the conductive transparent electrode and/or the transparent supply lines is formed by a material for a transparent conductive layer which comprises a transparent film, covered with non-transparent, conductive grid meshes, wherein this coverage is carried out in the form of thin, non-transparent wires, with the result that the film is transparent for the human eye.

18. A layer electrode according to claim 1 in a touchscreen in combination with a smartphone, a tablet, a computer or an electronic device.
